(19) United States
(12) Patent Application Publication
(10) Pub. No.: US 2007/0165057 A1
(43) Pub. Date: Jul. 19, 2007

(54) SUBSTRATE STRUCTURE AND METHOD FOR FORMING PATTERNED LAYER ON THE SAME

(75) Inventor: CHING-YU CHOU, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF Technology Co., Ltd., Hsinchu (TW)

(21) Appl. No.: 11/564,264

(22) Filed: Nov. 28, 2006

(30) Foreign Application Priority Data
Jan. 13, 2006 (TW) 095101346

(51) Int. Cl. B41J 2/205

(52) U.S. Cl. 347/15

(57) ABSTRACT

A substrate structure includes a substrate and a plurality of unitary layer partition walls with ink repellent characteristic provided on and connected with the substrate, the partition walls cooperatively defining a plurality of separated first accommodating rooms configured for containing ink therein, at least one of the partition walls includes at least a second accommodating room configured for receiving excessive amount of ink overflowing from the first accommodating rooms. A method for manufacturing a patterned layer includes the steps of: preparing a substrate structure; applying ink into first accommodating rooms; solidifying the ink in the first accommodating rooms to form a patterned layer on the substrate structure.

### BACKGROUND OF THE INVENTION

1. Field of the Invention

The present invention generally relates to a substrate structure and a method for forming a patterned layer on the substrate structure.

2. Description of Related Art

Conventional methods for manufacturing patterned layers are mainly classified into photolithography methods and ink jet methods.

Photolithography method: applying a photoresist layer on a substrate structure; exposing the photoresist layer using a photo-mask; developing the photoresist layer to form a patterned layer. This method is very complex and a large part of the photoresist material is wasted. Thus, this increases the cost.

Ink jet method: referring to FIG. 13, depositing ink 314 into many accommodating rooms defined by adjacent partition walls 304 formed on a substrate structure 300, then solidifying the ink 314 to form a patterned layer. When this method is employed, the required amount of ink can be saved since the ink is deposited into a required place only. Furthermore, since the patterned layer can be formed in fewer steps, the process is shortened, and it is possible to markedly reduce manufacturing costs. However, the ink 314 may flood one accommodating room, and overflow into an adjacent accommodating room and mix with the other ink therein, so quality of the patterned layer formed after solidifying is not optimal.

In solving of this problem, prior technologies provide a double layer partition wall, where the bottom layer of partition wall is made by the materials of black color material, and the upper layer is made by the other material and is formed into two isolated sidewall located on the bottom wall so that a overflow accommodating rooms is formed in there. The method is effect since two different materials are used. One is using black material used for color separation. The other material is used for ink separation. However, since two different layer is formed and then the process become complex. Thus the cost increases again, the benefit of ink jet method decreases.

What is needed, therefore, is a substrate structure configured to avoid ink overflow into adjacent accommodating rooms when producing patterned layers and a method for fabricating a patterned layer on the substrate structure.

### SUMMARY OF THE INVENTION

A substrate structure includes a substrate and a plurality of unitary layer partition walls with ink repellent characteristic provided on and connected with the substrate, the partition walls cooperatively defining a plurality of separated first accommodating rooms configured for containing ink therein, at least one of the partition walls includes at least a second accommodating room configured for receiving excessive amount of ink overflowing from the first accommodating rooms.

A method for manufacturing a patterned layer includes the steps of: preparing a substrate structure; depositing ink into first accommodating rooms; solidifying the ink in the first accommodating rooms to form the patterned layer on the substrate structure.

Compared with the conventional substrate structure, the present embodiments have the following advantages. At least one second accommodating room between adjacent first accommodating rooms is used to contain ink overflow from the first accommodating rooms, thus preventing mixing of the ink in adjacent first accommodating rooms. And unitary layer partition walls are used so that the process is fewer and cost is reduced.

Other advantages and novel features will become more apparent from the following detailed description of the present invention, when taken in conjunction with the accompanying drawings.

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic, plan view of a substrate structure according to a first preferred embodiment;

FIG. 2 is a schematic, cut-away view of the substrate structure of FIG. 1;

FIG. 3 is a schematic, cut-away view of an alternative substrate structure;

FIG. 4 is a schematic, plan view of a substrate structure according to a second preferred embodiment; and

FIG. 5 to FIG. 12 are side views showing stages of a method and procedures for manufacturing a substrate structure in accordance with a third preferred embodiment.

FIG. 13 is a schematic view of a conventional substrate structure.

Corresponding reference characters indicate corresponding parts throughout the drawings. The exemplifications set out herein illustrate at least one preferred embodiment of the present invention, in one form, and such exemplifications are not to be construed as limiting the scope of the invention in any manner.

### DETAILED DESCRIPTION OF THE EMBODIMENTS

Reference will now be made to the drawings to describe preferred embodiments of the present invention, in detail.

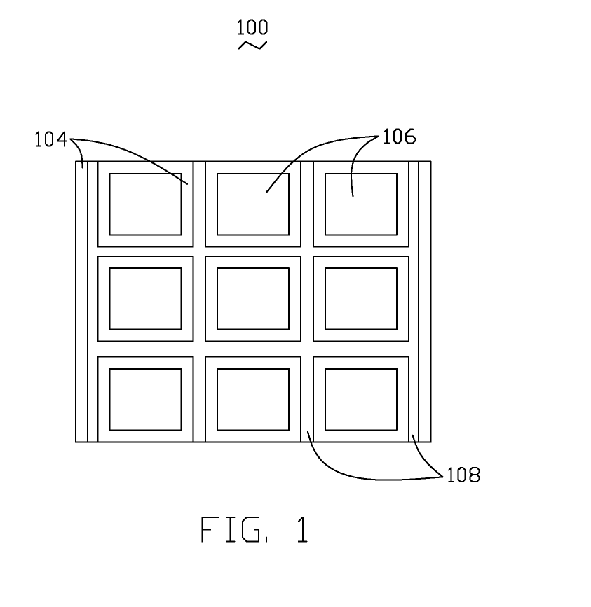

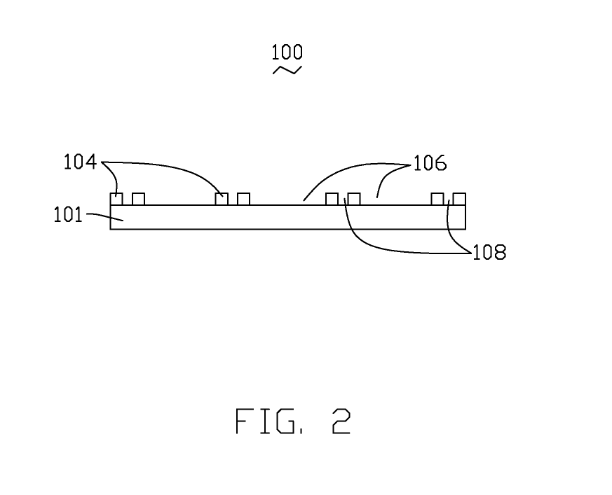

Referring to FIGS. 1 and 2, a substrate structure 100 in accordance with a first preferred embodiment is shown. The substrate structure 100 includes a substrate 101 and a plurality of unitary layer partition walls 104 provided on and connected with the substrate 101 by, for example, a photo-resist method as detailed below, or the substrate 101 and the partition walls 104 are formed from a single process. A material of the substrate 101 can be glass, silicon wafer, metal, plastics etc. In this embodiment the substrate 101 is glass.

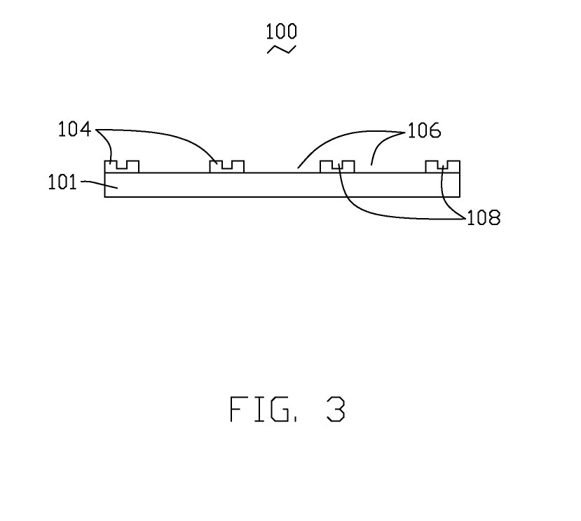

The partition walls 104 cooperatively define a plurality of separated first accommodating rooms 106 configured for containing ink deposited from an ink-jet device, at least one of the partition walls 104 includes one or more second accommodating rooms 108 configured for containing ink overflow from the first accommodating rooms 106, some of the second accommodating rooms 108 being arranged between adjacent first accommodating rooms 106, the second accommodating rooms 108 are in communication with each other. In this embodiment, some of the second accommodating rooms 108 cooperatively form a closed surrounding the corresponding first accommodating room 106 therein. The second accommodating rooms 108 are generally in a shape of a quadrate groove; and depths of the second accommodating rooms 108 are equal to that of the first accommodating rooms 106 (see FIG. 2), alternatively depths of the second accommodating rooms 108 may be less than that of the first accommodating rooms 106 (see FIG. 3). The second accommodating rooms 108 can also be defined as V-shaped grooves, U-shaped grooves, or other desired shapes as needed as far as they could contain ink. The partition walls 104 generally are made from resin, carbon black photoresist, or other pigment photoresist.

The unitary layer partition walls 104 of the substrate structure 100 should have appropriate ink repellent characteristic. The ink repellent characteristic of the partition walls 104 is refer that a contact angle between the ink and the partition wall 104 should be larger than about 15 degrees and less than about 90 degrees, preferably, larger than 20 degrees and less than 68 degrees. In this range the ink can be more likely to confine the ink in the first accommodating rooms 106 without influence the wetting ability of the substrate 101. In contrast, the prior technologies provide a substrate structure of double-layer partition walls that need a low contact angle material in bottom layer and high contact angle material in upper layer.

The substrate structure 100 includes a patterned layer formed in the first accommodating rooms 106. To fabricate the patterned layer in the first accommodating rooms 106, some amount of ink is deposited into the first accommodating rooms 106 respectively, and then solidified. If an amount of ink received in the first accommodating rooms 106 is excessive, overflow occurs, and the overflowing ink will be received and contained in the second accommodating rooms 108. Thereby avoiding mixing of different ink in first accommodating rooms 106, thus enhancing uniformity of the patterned layer and preventing short circuits when manufacturing conducting film patterned layers.

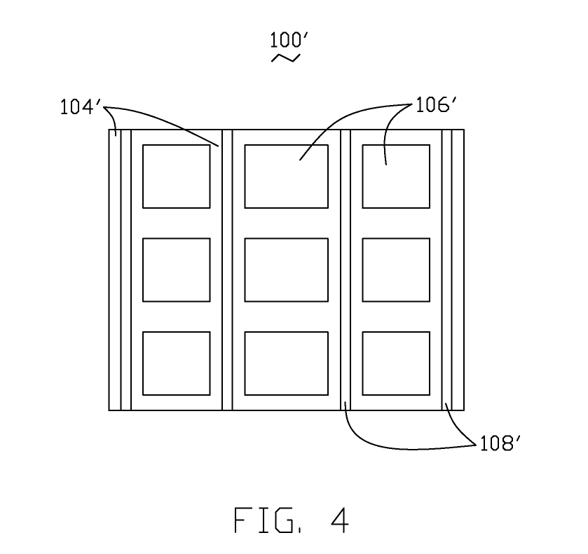

Referring to FIG. 4, a substrate structure 100′ in accordance with a second preferred embodiment is shown. The partition walls 104′ defines a plurality of first accommodating rooms 106′ configured for containing ink and arrayed in adjacent columns. And, there are a plurality of second accommodating rooms 108′ defined by the partition walls 104′ between adjacent columns of first accommodating rooms 106′ and along outside edges of the columns of first accommodating rooms 106′, configured for receiving and containing ink overflow from the first accommodating rooms 106′. A same ink is used in first accommodating rooms 106′ of a same column thereby eliminating a need for second accommodating rooms 108′ there between, however different inks may used in adjacent columns and are thus prevented from intermixing within first accommodating rooms 106′ by the second accommodating rooms 108′.

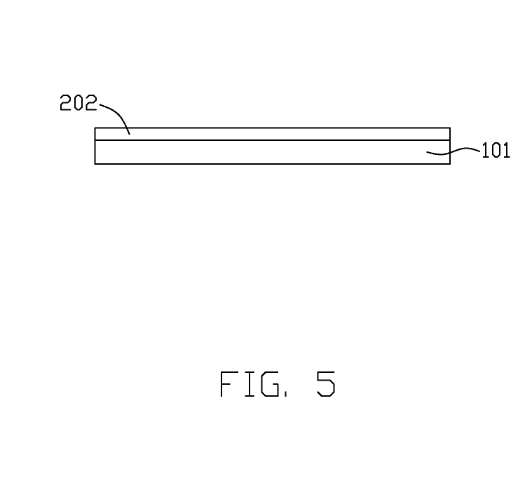

Referring to FIG. 5 to FIG. 12, a method for forming a patterned layer in accordance with a third preferred embodiment is shown, the method includes the following steps:

Step 1: preparing a substrate structure. The substrate structure can be the substrate structure 100 of the first preferred embodiment. Following are details of two different procedures that may be followed in preparing the substrate structure 100.

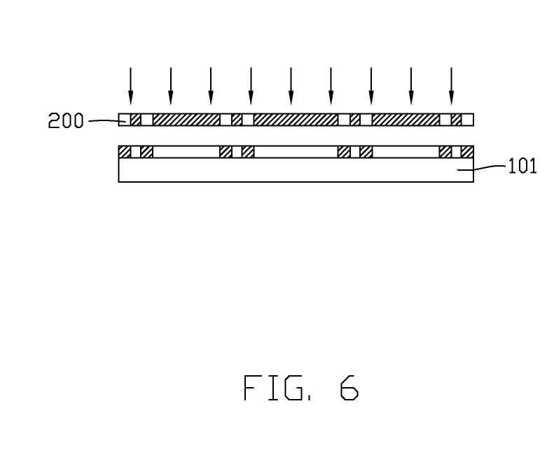

A first procedure for forming the substrate structure 100 includes the following steps: applying a first negative type photoresist film 202 on a surface of the substrate 101 by using a dry film coating, wet spin coating or wet slit coating (see FIG. 5); exposing the first negative type photoresist film 202 using a first mask 200 which has a pattern corresponding to the first accommodating rooms 106 and the second accommodating rooms 108 (see FIG. 6); developing the unexposed portions of the first negative type photoresist film 202 to form a patterned first photoresist film on the substrate 101 serving as the partition walls 104. In addition, in this method, a positive type photoresist film may be used; the differences are the mask has a reverse pattern and developing the exposed portions of the positive type photoresist film. The first mask 200 used in exposing process can be a grey-level mask. Also twice or more times of exposing steps can be used in exposing process: exposing the first photoresist film using a second mask which has a pattern corresponding to the first accommodating room and the second accommodating room, and then exposing the first photoresist film using a third mask which has a pattern corresponding to the first accommodating rooms.

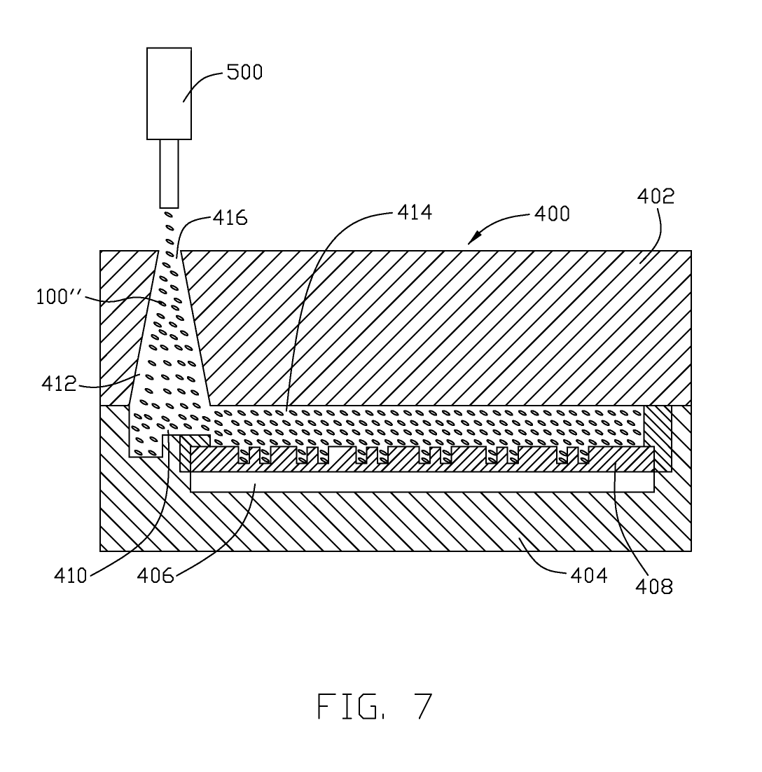

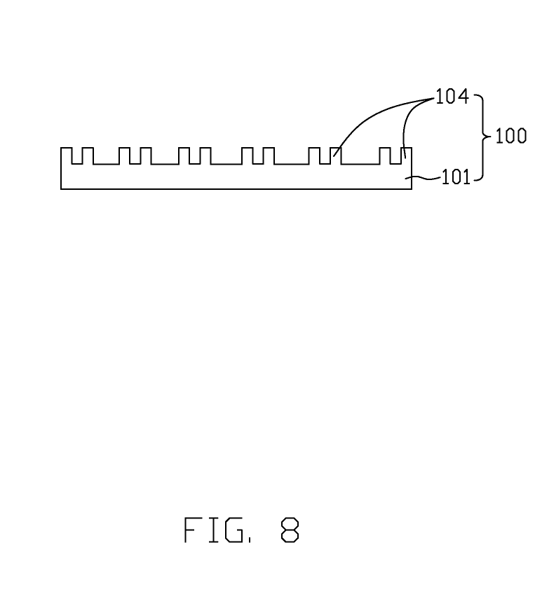

Referring to FIGS. 7 and 8, a second procedure for forming the substrate structure 100 includes the steps of: providing a injection machine 500 and a mold 400 having a pattern corresponding to partition walls; injecting a substrate structure material 100″ into the mold 400 by the injection machine 500 (see FIG. 7); molding a substrate structure 100 having the partition walls 104 on the substrate 101 (see FIG. 8). In this method, the substrate 101 and the partition walls 104 are formed as a single piece.

The mold 400 is formed of a stationary die 402 and a movable die 404. The stationary die 402 includes a sprue 416 and a runner 412, the sprue 416 is formed towards the movable die 404, and the runner 412 communicates with the sprue 416. A metal plate 406 is fixed on a bottom of the movable die 404. A model 408 has a pattern of partition walls and is fixed on the metal plate 406. The metal plate 406 and the model 408 cooperatively form a molding core. A runner 414 is formed along the two dies 402, 404. The runner 414 communicates with the sprue 416 and the runner 412 leading to a gate 410. The stationary die 402 and the movable die 404 are mated to form the runner 414 for molding the substrate structure 100. The runner 414 communicates with the sprue 416, the runner 412, and the gate 410. In this procedure, the substrate structure material 100″ is injected into the runner 414 through the sprue 416, the runner 412, and the gate 410 from the injection machine 500. Injection of the material 100″ continues until the runner 414 is completely filled. The material 100″ is then cooled, and the substrate structure 100 is removed from the mold 400.

The second procedure results in a substrate structure 100 having many partition walls 104. In addition, using a corresponding mold will form a substrate structure as shown in FIG. 2 or FIG. 3.

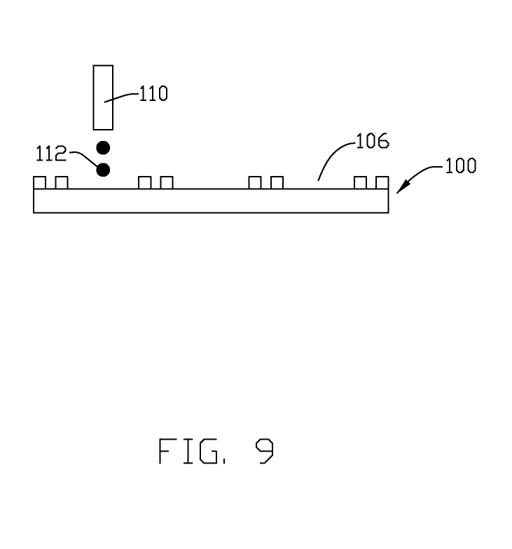

Step 2: depositing some amount of ink 112 into first accommodating rooms 106 using an ink-jet device 110 (see FIG. 9).

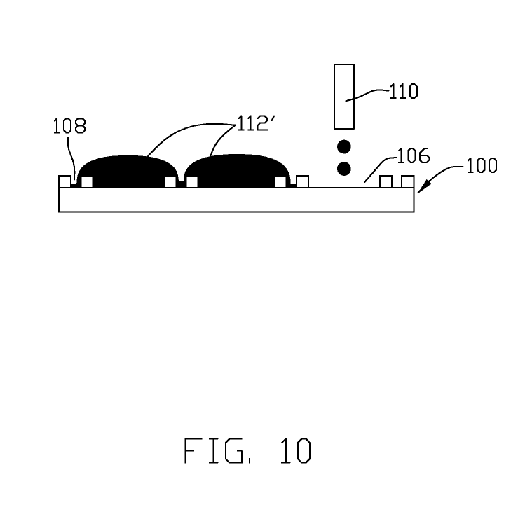

The ink-jet device 110 can be a thermal bubble ink jet printing apparatus or a piezoelectric ink jet printing apparatus. Any excess amount of ink 112′ overflowing from the first accommodating rooms 106 is received and contained in the second accommodating rooms 108 (see FIG. 10).

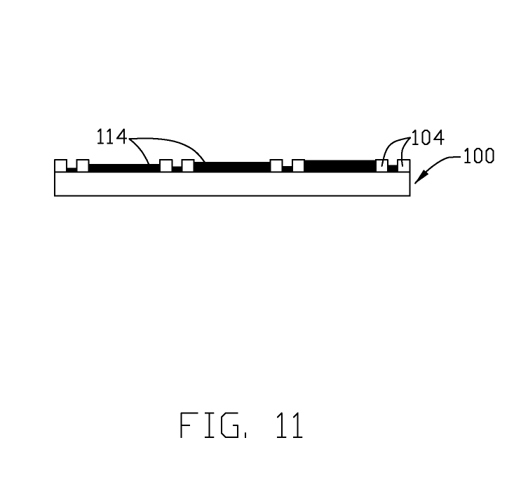

Step 3: solidifying the ink 112′ in the first accommodating rooms 106 by using one or more solidifying devices, such as vacuumizing devices and/or heating devices and/or light-exposure devices to form the patterned layer 114 (see FIG. 11).

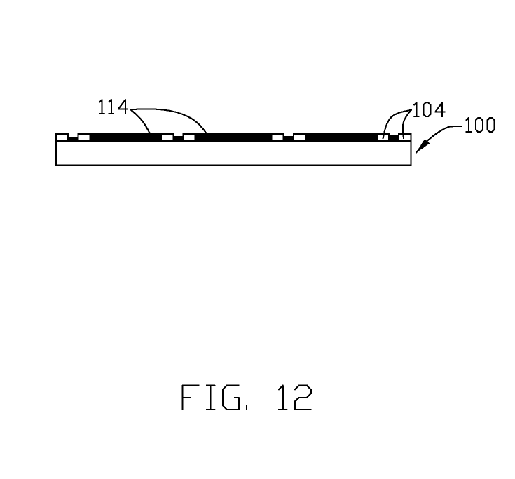

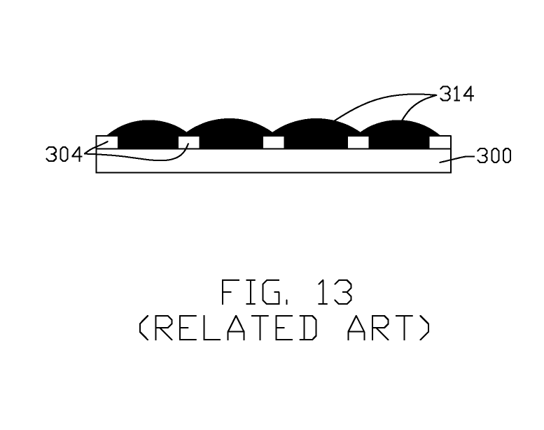

It should be noted that portions of the partition walls 104 higher than the color layer may be removed by a grinding method or an etching process (see FIG. 12).

The method for fabricating a patterned layer in accordance with a preferred embodiment can use the substrate structure 100′ in accordance with a second preferred embodiment.

In the present invention, the method for fabricating a patterned layer can be used to manufacture color filters and organic luminescence devices. In the color filter manufacturing process, the substrate structure is a color filter substrate and the red, green, and blue color strips (i.e. the patterned layer) can be formed in the first accommodating rooms on a substrate structure by the present method, the red ink, green ink, and the blue ink overflowed will be received and contained in the second accommodating rooms, to preventing mixing of the red ink, green ink, or the blue ink in adjacent first accommodating rooms. Correspondingly, the partition walls mentioned above are black matrix wall. In the organic luminescence device manufacturing process, conductive layers, emitting layers, and hole transport layers can be formed by the present method, but using ink known to those skilled in the art specially formulated to form the patterned layer.

It is to be understood that the above-described embodiments are intended to illustrate rather than limit the invention. Variations may be made to the embodiments without departing from the spirit of the invention as claimed. The above-described embodiments are intended to illustrate the scope of the invention and not restrict the scope of the invention.

What is claimed is:

1. A substrate structure, comprising:
a substrate;
a plurality of unitary layer partition walls with ink repellent characteristic provided on and connected with the substrate, the partition walls cooperatively defining a plurality of separated first accommodating rooms configured for containing ink therein, at least one of the partition walls includes at least a second accommodating room configured for receiving excess amount of ink overflowing from the first accommodating rooms;
a patterned layer formed in the first accommodating rooms.

2. The substrate structure of claim 1, wherein the partition walls are made from one of resin, carbon black photoresist.

3. The substrate structure of claim 1, wherein a material of the substrate is selected from a group of glass, silicon wafer, metal and plastics.

4. The substrate structure of claim 1, wherein the substrate and the partition walls are formed from a single process.

5. The substrate structure of claim 1, wherein at least some of the second accommodating rooms are in communication with each other.

6. The substrate structure of claim 1, wherein at least some of the second accommodating rooms cooperatively form a closed channel surrounding the corresponding first accommodating room therein.

7. The substrate structure of claim 1, wherein the ink repellent characteristic of the partition walls is refer that a contact angle between the ink and the partition wall is lager than 15 degrees and less than 90 degrees.

8. The substrate structure of claim 1, wherein the ink repellent characteristic of the partition walls is refer that a contact angle between the ink and the partition wall is lager than 20 degrees and less than 68 degrees.

9. A method for forming a patterned layer on a substrate structure, comprising the steps of:
preparing a substrate structure of claim 1;
depositing ink into the first accommodating rooms; and
solidifying the ink in the first accommodating rooms to form the patterned layer on the substrate structure.

10. The method of claim 9, wherein a procedure for preparing the substrate structure comprising the steps of:
providing a substrate;
applying a first photoresist film on the substrate;
exposing the first photoresist film using a first mask which has a pattern corresponding to the first accommodating rooms and the second accommodating rooms; and
developing the first photoresist film to form a patterned first photoresist film on the substrate serving as the partition walls.

11. The method of claim 10, wherein the first mask is a gray-level mask.

12. The method of claim 10, wherein the substrate structure is a color filter substrate and the patterned layer is a color strips.

13. The method of claim 9, wherein a procedure for preparing the substrate structure comprising the steps of:
providing a substrate;
applying a first photoresist film on a surface of the substrate;
exposing the first photoresist film using a second mask which has a pattern corresponding to the first accommodating rooms and second accommodating room
exposing the first photoresist film using a third mask which has a pattern corresponding to the first accommodating rooms;
developing unexposed portions of the first photoresist film;
removing remaining portions of the first photoresist film to form the partition walls on the substrate.

14. The method of claim 9, wherein a procedure for preparing the substrate structure comprising the steps of:
providing a mold having a pattern corresponding to the partition walls;
injecting a material of the substrate structure into the mold by an injection machine; and
molding a substrate structure having the partition walls thereon.

15. The method of claim 9, wherein the step of solidifying the ink in the first accommodating rooms is performed by a device selected from a group consisting of a vacuumizing device, a heating device, a light-exposure device and any combination thereof.
